(19) United States
(12) Patent Application Publication
(10) Pub. No.: US 2010/0022285 A1
(43) Pub. Date: Jan. 28, 2010

(54) APPARATUS AND METHOD FOR RETROFITTING A BROAD RANGE OF MOBILE DEVICES TO RECEIVE WIRELESS POWER

(75) Inventors: Mitch Randall, Boulder, CO (US); Daniel W. Hoekstra, Lafayette, CO (US)

Correspondence Address: COCHRAN FREUND & YOUNG LLC, 2026 CARIBOU DR, SUITE 201, FORT COLLINS, CO, 80525, US

(73) Assignee: Wildcharge, Inc., Boulder, CO (US)

(21) Appl. No.: 12/472,337

(22) Filed: May 26, 2009

Related U.S. Application Data
(63) Continuation-in-part of application No. 12/397,348, filed on Mar. 3, 2009.
(60) Provisional application No. 61/055,510, filed on May 23, 2008.
(60) Provisional application No. 61/033,229, filed on Mar. 3, 2008.

(51) Int. Cl. H04B 1/38

(52) U.S. Cl. 455/573

(57) ABSTRACT

Apparatus and method for retrofitting a mobile electronic device, which has an input power receptacle located on its side, to receive power from a power delivery pad that has a flat power delivery surface. A connector assembly is connectable to the mobile electronic device by plugging a connector into the input power receptacle of the device. A power receiver assembly connects pivotally and electrically to the connector assembly by magnetism. The power receiver assembly is pivotal to position a power receiver hub, which is at a fixed distance from the connector assembly, over an axis of the mobile device, where an anchor comprising magnetic material or a mechanical attachment apparatus is adhered to the surface of the mobile device, and the hub is attached to the anchor by magnetism also, so that it is simply and easily detachable and re-attachable. The connector is adjustable in the connector assembly to position the power receiver assembly flush with the surface of the mobile device. Alternate connector assemblies with differently configured connectors are attachable magnetically or mechanically to the power receiver assembly.

### CROSS-REFERENCES TO RELATED APPLICATIONS

This application claims the benefit of U.S. Provisional Application No. 61/055,510, filed May 23, 2008, and it is a continuation-in-part of U.S. patent application Ser. No. 12/397,348, filed Mar. 3, 2009, which claims the benefit of U.S. Provisional Application No. 61/033,229 filed Mar. 3, 2008, all of which are incorporated herein by reference.

### BACKGROUND OF THE INVENTION

1. Field of the Invention

The present invention relates to electronic systems and methods for providing electrical power and/or data to one or more electronic or electrically powered devices with a power delivery surface.

2. State of the Prior Art

A variety of electronic or electrically powered devices, such as toys, game devices, cell phones, laptop computers, cameras, and personal digital assistants, have been developed along with ways for powering them. Mobile electronic devices typically include and are powered by batteries which are rechargeable by connecting them through power cord units, which include transformers and/or power converters, to a power source, such as an electric wall outlet or power grid, an automobile or other vehicle accessory electric outlet plug receptacle or the like, either during use of the electronic device or between uses. A non-mobile electronic device is generally one that is powered through a power cord unit and is not intended to be moved during use any farther than the reach of the power cord, so it generally does not have or need batteries for powering the device between plug-ins.

In a typical set-up for a mobile device, the power cord unit includes an outlet connector or plug for connecting it to the power source and a battery connector for connecting it to a corresponding battery power receptacle of the battery. The outlet connector or plug and battery connectors are in communication with each other so electrical signals flow between them. In this way, the power source charges the battery through the power cord unit.

In some setups, the power cord unit may include a power adapter, transformer, or converter connected to the outlet and battery connectors through AC input and DC output cords, respectively. The power adapter adapts an AC input voltage received from the power source through the outlet connector and AC input cord to output a DC voltage through the DC output cord. Others include adapters, transformers, or converters connected to the outlet and battery connectors through DC input and DC output cords. The DC output current flows through the receptacle and is used to charge the battery.

Manufacturers, however, generally make their own models of electronic devices and do not make their power cord unit compatible with the electronic devices of other manufacturers, or with other types of electronic devices. As a result, a battery connector made by one manufacturer will typically not fit into the battery power receptacle made by another manufacturer. Further, a battery connector made for one type of device typically will not fit into the battery power receptacle made for another type of device. Manufacturers make these connectors unique to their own devices for several reasons, such as cost, liability concerns, different power requirements, and to acquire or hold a market share.

However, the proliferation of unique power cords that are not compatible with other devices can be troublesome for consumers because they have to buy unique power cord units for their particular electronic devices and deal with the plethora of different power cords required for their devices. Since people tend to switch devices often, it is inconvenient, expensive, and wasteful for them to also have to switch power cord units, too. Unfortunately, power cord units that are no longer useful are often discarded, which is also wasteful and harmful to the environment. Also, people generally own a number of different types of electronic devices and owning a power cord unit for each one is inconvenient because the consumer must deal with a large quantity of power cord units and the confusion and tangle of power cords the situation creates.

A recent solution to this problem of individual power adapters and cords unique to specific mobile electronic devices and not compatible to other mobile electronic devices has included the development of a power delivery pad with a flat power delivery surface comprising a plurality of power delivery contact pads that can deliver electric power to a variety of different mobile devices without connecting power cords to the mobile devices, i.e., wireless power delivery. One or more than one mobile device can simply be placed on the flat power delivery surface of the power pad and receive power from the power pad for charging batteries in the mobile devices and/or for powering the mobile devices. However, the mobile devices have to be equipped with compatible power receiver apparatus and circuitry in order to receive the electric power.

Most mobile devices are not manufactured with power receiver apparatus and circuitry adapted to receive power from such power pads. Therefore, to receive power from such power pads, most mobile electronic devices have to be retrofitted or otherwise provided with appropriate receiver contact apparatus and power conditioning circuitry in order to be charged or operated on the power delivery surface of the power delivery pad instead of with their unique power cords.

### BRIEF DESCRIPTION OF THE DRAWINGS

The accompanying drawings, which are incorporated in and form a part of the specification, illustrate some, but not the only or exclusive, example implementations of the invention. It is intended that the example embodiments and figures included herein are considered to be illustrative rather than limiting.

In the drawings:

FIG. 1 is a perspective view of a mobile, electronic device equipped with a universal power receiver adapter and located above a power delivery pad in a position where the device can be lowered onto the power delivery surface of the power delivery pad to receive electric power;

FIG. 2 is a view of the bottom of a mobile electronic device equipped with the universal power receiver adapter;

FIG. 3 is a view of another mobile electronic device equipped with the universal power receiver adapter;

FIG. 4 is a view of another mobile electronic device equipped with the universal power receiver adapter;

FIG. 5 is another mobile electronic device equipped with the universal power receiver adapter;

FIG. 6 is a perspective view of an example embodiment of the universal power receiver adapter;

FIG. 7 is a perspective view of the universal power receiver adapter of FIG. 6 illustrating two example alternative connector assemblies in relation to the power receiver assembly;

FIG. 8 is a bottom plan view of the power receiver assembly;

FIG. 9 is a side elevation view of the example universal power receiver adapter with its connector assembly plugged into a mobile electronic device shown in phantom lines and with an attachment assembly also affixed to the mobile electronic device;

FIG. 10(a-d) are diagrammatic illustrations of example different thicknesses and receptacle spacing of different mobile electronic devices;

FIG. 11 is a side elevation view of the connector assembly illustrating adjustable positioning of the plug assembly in the connector assembly;

FIG. 12 is an isometric view of the example universal power receiver adapter with portions of the skin removed to reveal interior components;

FIG. 13 shows a cross-section of the example universal power receiver assembly taken along section line 13-13 in FIG. 6;

FIG. 14 is a cross-section of the connector assembly taken along section line 14-14 of FIG. 6; and

FIG. 15 is a cross-sectional view similar to FIG. 13, but showing example mechanical connections of the power receiver arm to the connector assembly and of the power receiver assembly to the mobile electronic device.

### DETAILED DESCRIPTION OF EXAMPLE EMBODIMENTS

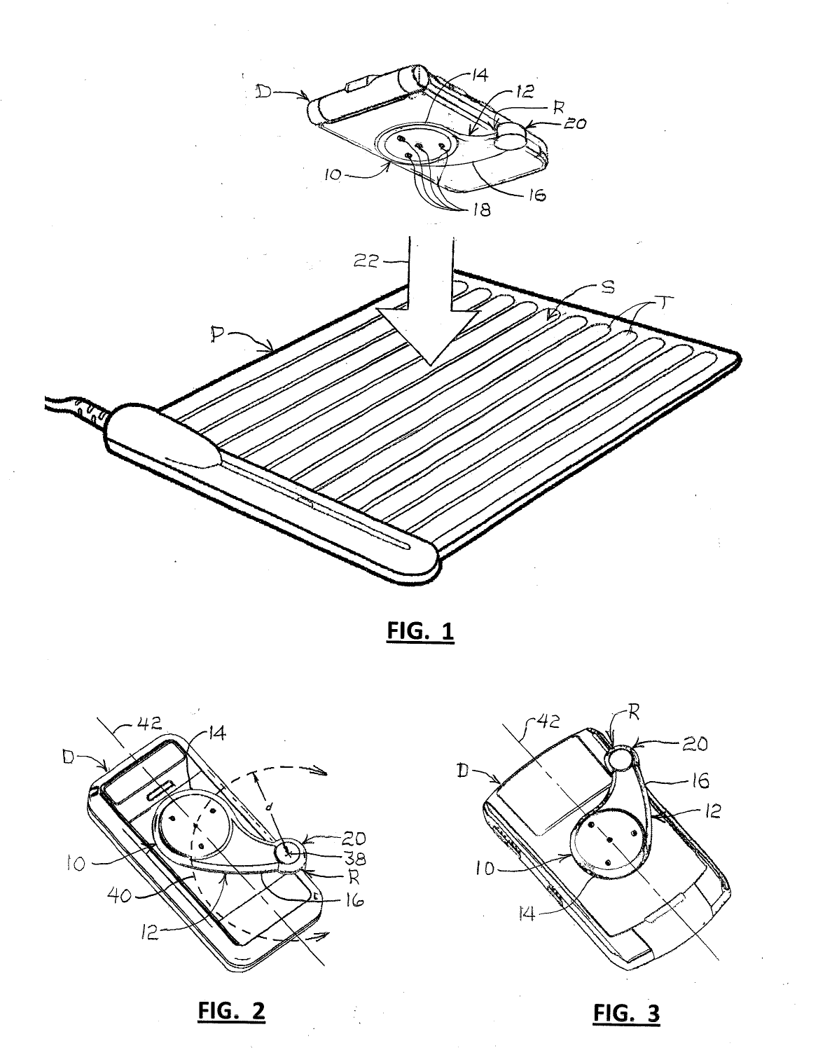

An example universal power receiver adapter 10 is shown in FIG. 1 mounted, for example, on the bottom or back side of a mobile electronic or electrically powered device D for enabling the mobile electronic device D to receive charging and/or operating power from a power delivery pad P. This universal power receiver adapter 10 is an illustration of one example implementation of the invention, but recognizing that the invention recited in the claims below can also be implemented in myriad other ways, once the principles are understood from the description herein.

The mobile electronic device D depicted in FIG. 1 and other figures herein is a generic representation of any number of mobile electronic devices available commercially, such as cell phones, personal digital assistants, cameras, computers, games, toys, calculators, global positioning satellite (GPS) locating devices, test equipment, tools, and many others. The device D illustrated in FIG. 1 is typical of a size and shape for being hand-held, although a mobile electronic device can be any electronic device that can be carried easily by a typical person. Generally, such mobile electronic devices are powered by rechargeable batteries that have to be recharged periodically, and they have an input power receptacle R, such as a jack, plug, or other connector on a side or end for mating with a power cord connector to bring in power from an external power source to recharge the batteries.

The universal power receiver adapter 10 is provided to retrofit such mobile electronic devices D to receive power from a power delivery pad P that has a flat power delivery surface S on which one or more mobile electronic devices D can be placed at more or less random locations to receive power. The example power delivery pad P shown in FIG. 1 is not, itself, part of this invention, but it is illustrated to make it easier to understand the universal power receiver adapter 10. Essentially, a mobile electronic device D retrofitted with the universal power receiver adapter 10 can be placed on the power delivery pad P with the power receiver hub 14 on the power delivery surface S of the power delivery pad P and receive power from the power delivery pad P. The received power is rectified and conditioned in the power receiver assembly 12 of the universal power receiver adapter 10 for use by the mobile electronic device D and is transmitted to the connector assembly 20, which is mated physically and electrically with the input power receptacle R of the mobile electronic device D for coupling the power into the device D. The power can be transferred from the power delivery pad P to the power receiver hub 14 conductively, inductively, or any other convenient power transfer system. The apparatus illustrated in FIG. 1 is depicted, for example, as conductive power transfer apparatus, wherein a plurality of conductive power receiver contacts 18 on the power receiver hub 14 make physical contact with power transfer contacts T in the power delivery surface S, when the mobile electronic device D is placed on the power delivery pad P. However, as mentioned above, the power transfer from the power delivery pad P to the power receiver assembly 12 can also be accomplished inductively. For inductive power transfer, one or more electromagnetic transmitter coil (not shown) can be used in the power delivery pad P instead of the power transmitter contacts T, and one or more inductive power pickup coils (not shown) can be used in the power receiver hub 14 instead of the conductive power receiver contacts 18.

Again, the power delivery pad P and the means of actual power transfer used to get power from the power delivery pad P into the power receiver assembly 12, whether conductive, inductive, or some other power transfer means, is not a part of this invention. For a more complete understanding of an example power transfer system, one can reference, for example, the U.S. Pat. No. 7,172,196, issued to Mitch Randall, on Feb. 6, 2007, which is incorporated herein by reference. The universal power receiver adapter 10 is provided to retrofit a wide variety of commercially available mobile electronic devices D to receive power from such power delivery pads P by providing a power receiver assembly 12, including a power receiver hub 14 for interfacing with the power delivery surface S of the power delivery pad P with whatever power transfer components, e.g., conductive, inductive, or others, are needed to receive power from the power delivery pad P, and to couple the received power into the power input receptacle R of the mobile electronic device D. Doing so in a minimally obtrusive and aesthetically pleasing manner is a plus. With these understandings, and with no intent to limit the scope of the invention as defined by the claims, the description herein will proceed for convenience, with the drawings illustrating, for example, a conductive power transfer system in which power is transferred by a physical contact of a plurality of electrically conductive power receiver contacts 18 in the power receiver hub 14 with a plurality of electrically conductive metal power transfer contacts T, at opposite polarities or at different electrical potentials, that comprise the power delivery surface S. There are benefits from configuring the power receiver contacts 18 may or may not be configured in a manner that provides power transfer from the power delivery surface S regardless of the orientation at which the mobile electric device D is placed on the power delivery surface S, but such configurations are not strictly required for the universal power receiver adapter 10 to be useful.

Also, it is apparent from FIG. 1, and as explained above, that the universal power receiver adapter 10 is mounted on a surface of the mobile electronic device D that will face the power delivery pad P when the device D is placed on the power delivery pad P for receiving power. For many mobile electronic devices D, such as cell phones or other devices that have visual or tactile user interfaces on front or top surfaces, it may be convenient or preferable, but not essential, to mount the universal power receiver adapter 10 on a back surface of the mobile electronic device D. For some devices D, such mounting may be on a battery cover or other panel that may need to be removed from time to time. Also, while retrofitting a mobile electronic device D with the universal power receiver adapter 10 may be done in order to obtain power for the device D primarily from a power delivery pad P, there may still be occasions in which a user may want or need to revert to use of a conventional power cord (not shown) to receive power or to transfer data into the mobile electronic device D via the input receptacle R. For example, if a charge is needed at a location where a power delivery pad P is not available, a user may have to resort to using the original power cord. Therefore, while it may be desirable to mount the universal power receiver adapter 10 on the mobile electronic device D in a secure and even permanent or semi-permanent manner, it is also desirable to be able to remove it or disconnect it from the mobile electronic device D and to easily and quickly remount or reconnect it. The universal power receiver adapter 10 can accommodate these desires or needs, as will be explained in more detail below.

Also, while it is understood that the universal power receiver adapter 10 may usually be mounted on a back or bottom surface of the mobile electronic device 10, as explained above, it is convenient and perhaps more easily understandable for the description of the universal power receiver adapter 10 herein to proceed as if one is viewing it in an orientation as it would appear when the mobile electronic device D on which it is mounted is held or placed on a surface in a manner to facilitate such viewing, i.e., with the surface of the device D on which the universal power receiver adapter 10 is mounted facing generally upward, as seen, for example, in FIGS. 2-7 and 9-13. Therefore, references to top, bottom, up, down, over, under, right, left, and the like are made in the description with this orientation, even though it is understood that they may not be oriented the same when the mobile electronic device D is in actual use or when it is placed on a power delivery pad P to receiver power.

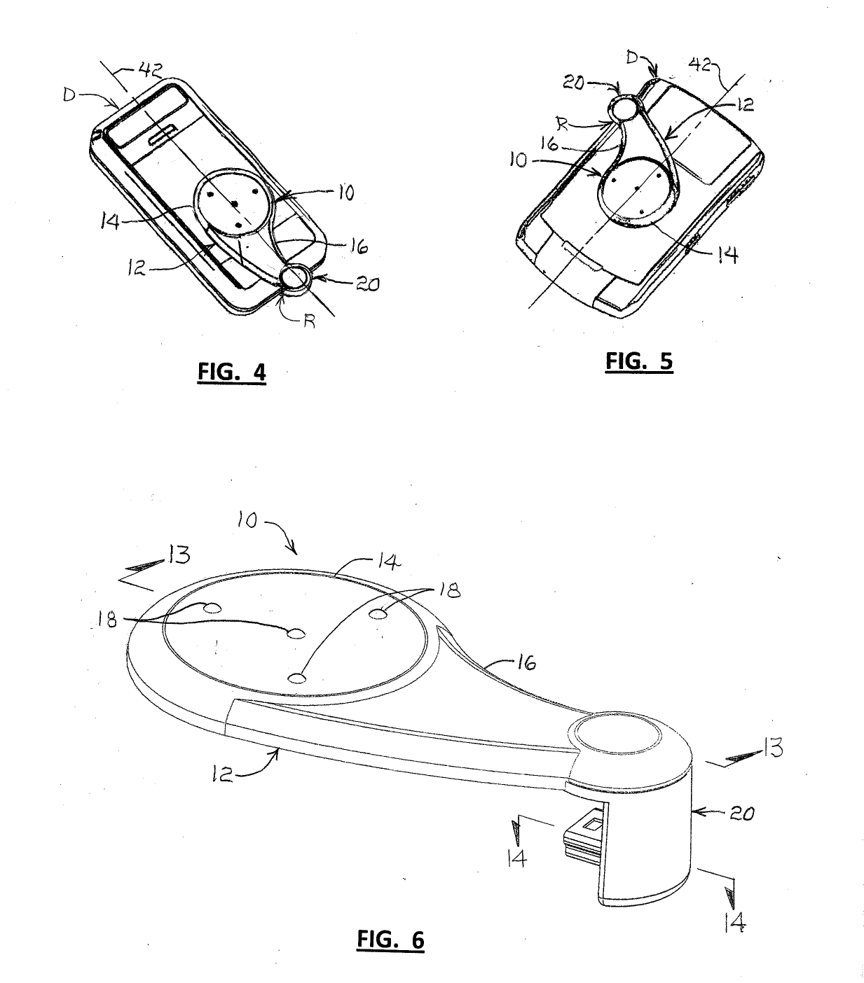

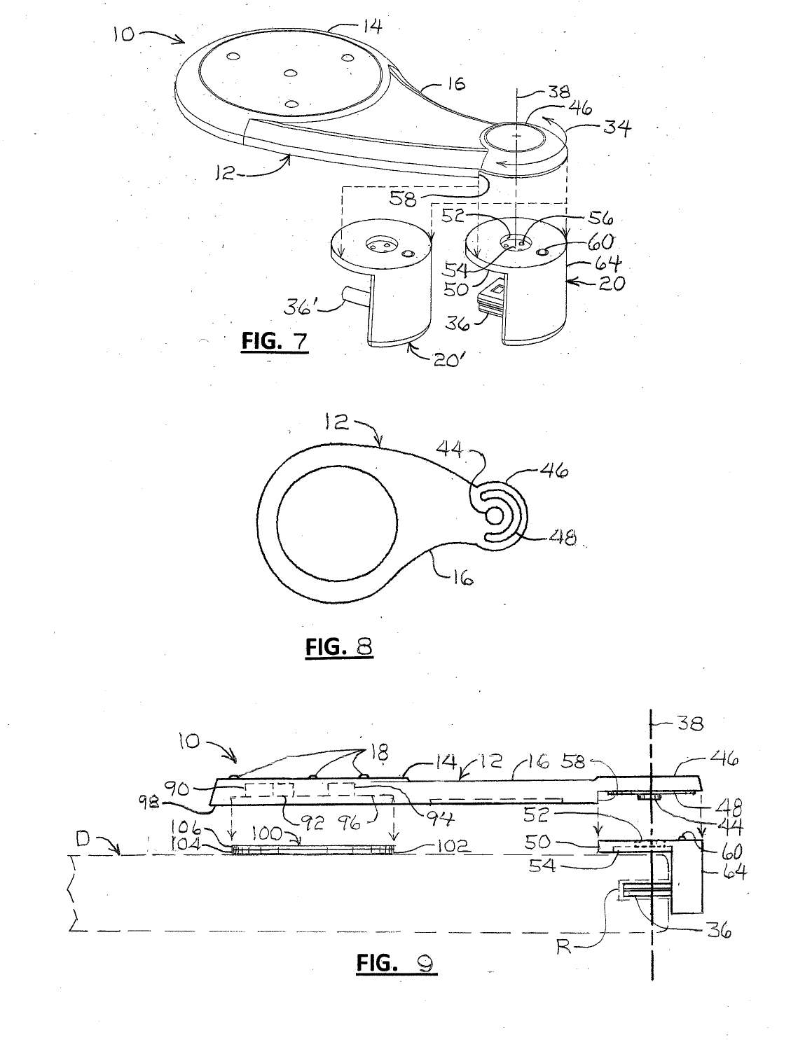

As illustrated in FIGS. 2-5, the universal power receiver adapter 10 can be used to retrofit a variety of different mobile electronic devices D for receiving power from a power delivery pad P, as explained above. For example, but not for limitation, the mobile electronic device D in FIG. 2 has its input power receptacle R located toward its lower right corner, whereas the mobile electronic devices D in FIGS. 3, 4, and 5 are illustrated with their input power receptacles R located toward the upper right corner (FIG. 3), lower end (FIG. 4), and upper left (FIG. 5), respectively. To accommodate these and other locations of input power receptacles R on a variety of mobile electronic devices D, the power receiver assembly 12 of the universal power receiver adapter 10 is rotatable with respect to the connector assembly 20, as illustrated, for example, by the arrow 34 in FIG. 7, as will be explained in more detail below.

Essentially, when the connector assembly 20 is connected to the input power receptacle R of a particular mobile electronic device D, as shown in FIGS. 2-5, the center of the power receiver hub 14, which is at a fixed distance d from the pivot axis 38 of the power receiver assembly 12 with respect to the connector assembly 20, rotates in an arc 40 about the pivot axis 38 (see FIG. 2). Therefore, the power receiver assembly 12 can be attached to the mobile electronic device D with the center of the power receiver hub 14 any place on the arc 40 where it is on the device D. Generally, however, for balance and appearance, a user may want to attach the power receiver assembly 12 to the surface of the mobile electronic device D where the center of the power receiver hub 14 coincides with the longitudinal axis or centroid 42 of the device D, as shown in FIGS. 2-5. The universal power receiver adapter 10 can be made with a distance d that allows the power receiver assembly 12 to be mounted in this manner on a variety of different mobile electronic devices D. Considerations such as balance, stability, ability of hold-down magnets (discussed later) to hold the power receiver hub 14 tightly and in a flush manner on the power delivery surface S may, but do not have to be, used in determining the distance d for particular power receiver assemblies 12.

Also, different mobile electronic devices D may have different input power receptacle R configurations. Therefore, the connector assembly 20 can be made with different plugs, jacks, or other configurations 36, 36′, as shown, for example, in the interchangeable connector assemblies 20, 20′ in FIG. 7, to mate with various different input power receptacles R. Of course, there are a variety of other shaped or differently configured input power receptacles that are not shown in FIG. 7, but the connector assembly 20 can be made withy any typical plug, jack, or fitting to mate with typical input receptacles R. When such alternate connector assemblies 20 are made to be interchangeable, as illustrated by the interchangeable connector assemblies 20, 20′ in FIG. 7, any of them can be used with the same power receiver assembly 12. Since the power receiver assembly 12 comprises more circuit and other components than the connector assemblies 20, as illustrated, for example, in FIG. 12, thus significantly more expensive to manufacture, it is advantageous to provide less expensive, alternate connector assemblies 20, with different plugs, jacks, or other connectors 36 to mate the universal power receiver adapter 10 to different mobile electronic devices D with different input power receptacles R, all of which can be used with the same power receiver assembly 12.

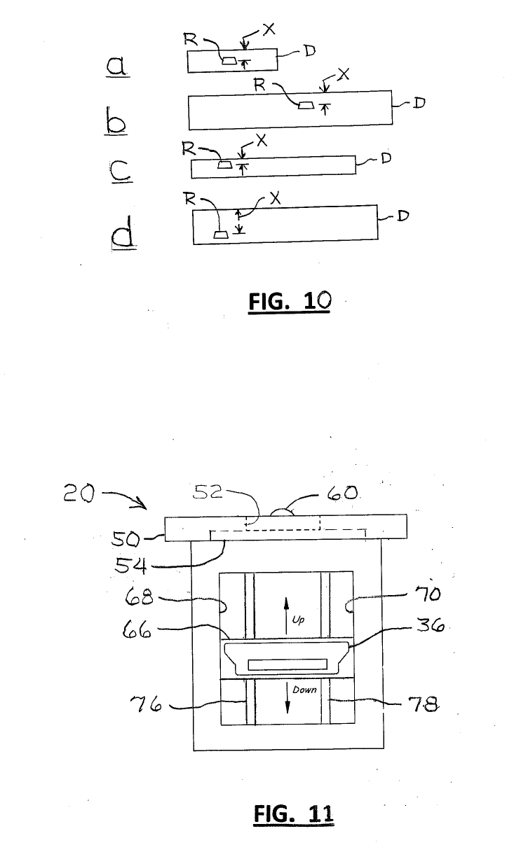

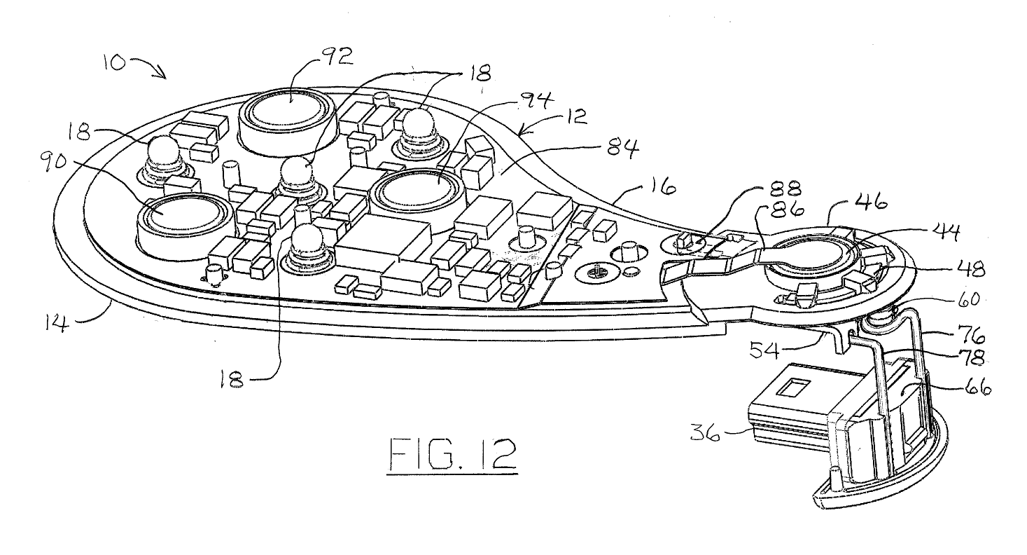

Also, as illustrated in FIGS. 10a-d, different mobile electronic devices D may have their receptacles R placed at different dimensions X from the top surface of the respective devices D. Therefore, in order to mount the universal power receiver adapter 10 on the various different mobile electronic devices D with the power receiver assembly 12 on or as close to the top surface of the devices D as possible, the plug, jack, or other connector 36 is mounted in the connector assembly 20 in an adjustable manner so that it can be adjusted upwardly and downwardly, as shown, for example, in FIG. 11.

Referring, now, primarily to FIGS. 7-9 with secondary reference to FIGS. 12-14, the power receiver assembly 12 attaches rotatably to the connector assembly 20, so that it can pivot about the axis 38, as explained above, to fit on a variety of different mobile electronic devices D. It is also useful for the attachment of the power receiver assembly 12 to the mobile electronic device D to be easily detachable and re-attachable, as also explained above. Also, it is desirable to have the power receivable assembly 12 attachable easily to alternate connector assemblies 20, 20′, as explained above, and, for ease of detaching and reattaching the power receiver assembly 12 and/or the connector assembly 20 from and to the mobile electronic device D, it may also be desirable to have the power receivable assembly 12 and the connector assembly 20 easily detachable and re-attachable from and to each other. The pivotal joint or attachment of the power receiver assembly 12 to the connector assembly 20 also conducts electric current from the power receiver assembly 12 to the connector assembly 20 for connection via the plug, jack, or other connector 36 to the mobile electronic device D. Magnetic attachment of the power receiver assembly 12 to the connector assembly 20 and a combination of adhesive and magnetic attachment of the power receiver assembly 12 to the mobile electronic device D as described below is one, but not necessarily the only, way to provide these easily attachable and detachable and rotatable functionalities.

As best seen in FIGS. 7-9 and 13, the rotatable joint or attachment of the power receiver assembly 12 to the connector assembly 20 in the example universal power receiver adapter 10 comprises a cylindrical, electrically conductive magnet electrode 44 mounted in and protruding downwardly from the proximal end portion 46 of the power receiver arm 16 of the power receiver assembly 12. An annular or semi-annular, electrically conductive, electrode 48 surrounds or partially surrounds the protruding magnet electrode 44 a radially spaced distance outwardly from the magnet electrode 44, as best seen in the bottom plan view of the power receiver assembly 12 in FIG. 8, so that the two electrodes 44, 48 can be at opposite polarities to carry electric current from the power receiver assembly 12 to the connector assembly 20.

The top of the connector assembly 20 includes a flange 50 with top surface sized and shaped to interface with the bottom surface of the proximal end 46 of the power receiver arm 16. The flange 50 has a cylindrical recess or hole 52 that is sized to receive the protruding magnet electrode 44, which extends into the flange 50 to an electrically conductive plate 54 comprising magnetic material, which is embedded in, and/or affixed to, the flange 50. The magnet electrode 44 is long enough to extend through the hole 52 to contact the plate 54 before the bottom surface of the power receiver arm 16 or the annular electrode 48 touch the top surface of the flange 50 to ensure good electrical contact between the magnet electrode 44 and the plate 54 to carry electric current.

The magnetic attraction of the plate 54 to the magnet electrode 44 holds the plate 54 in firm electrical contact with the plate 54. At the same time, the lateral, but not rotational, confinement of the cylindrical magnet electrode 44 by the cylindrical hole 52 defines the rotation axis 38 and allows rotation or pivoting of the power receiver assembly 12 about the axis 38 in relation to the connector assembly 20, as described above. One pole of the plug, jack, or other connector 36 is connected electrically to the plate 54 to complete one leg of the electric circuit from the power receiver assembly 12 to the plug, jack, or other connector 36.

One or more raised points 56 can be formed into the plate 54, for example, by pressing dimples into the bottom of the plate 54, to ensure good electrical contact between the magnet contact 44 and the plate 54, regardless of whether the vertical angle between the power receive arm 16 and the connector assembly 20 may vary. Therefore, the protrusion of the magnet electrode 44 into the hold 52 to contact the plate 54 may be just long enough to hold the flange 50 and the power receiver arm 16 slightly apart enough to accommodate some vertical angle variation between the power receiver arm 16 and the connector assembly 50, but not so much as to hold the power receiver arm 16 a significant distance above the surface of the mobile electronic device D. The bottom portion of the proximal end portion 46 of the power receiver arm 16 is recessed enough as indicated at 58 in FIGS. 7, 9, and 13, to accommodate the flange 50 in a manner that makes the bottom surface of the flange at or near flush with the bottom surface of the power receiver arm 16 for an appropriate placement of the bottom surfaces of the flange 50 and power receiver arm 16 on or only slightly above the surface of the mobile electronic device D.

An electrically conductive, compliant contact point 60 is mounted in the connector assembly 50 to protrude above the top surface of the housing 52 of the connector assembly 50 enough to contact the annular or semi-annular electrode 48 (sometimes generically called annular electrode for convenience) and to maintain sliding contact with the annular electrode 48 as the power receiver arm 16 pivots about the axis 38 in relation to the connector assembly 20. Therefore, the contact point 60 couples the other leg of the electric circuit from the power receiver assembly 12 into the connector assembly 20. The contact point 60 is connected electrically to the other pole of the connector 36 to complete the circuit from the power receiver assembly 12 to the connector 36. Therefore, when the connector 36 is mated with the receptacle R of the mobile electronic device D, as illustrated diagrammatically in FIG. 9, the electric circuit from the power receiver assembly 12 is conducted through the rotatable joint and connector assembly 50 to the mobile electronic device D.

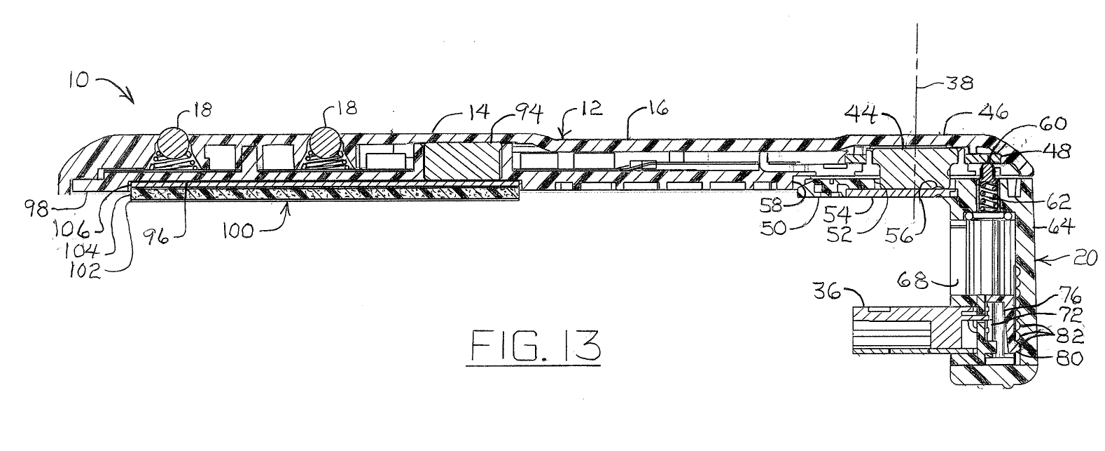

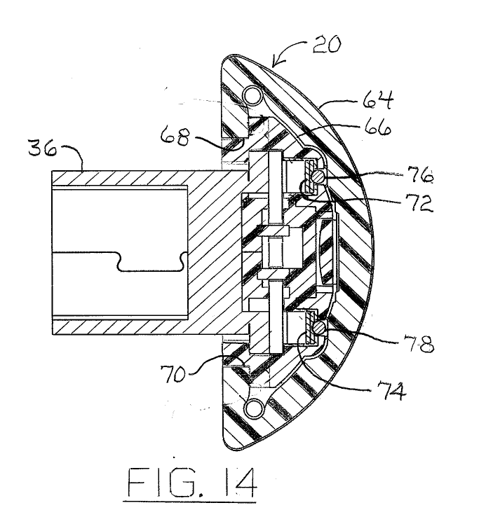

The point contact 60 can be made compliant in myriad ways. In the example universal power receiver adapter 10, the point contact 60 is spring loaded, as shown in FIG. 13, with a coiled compression spring 62, although other kinds of springs or resilient materials could also be used. The magnetic force attraction of the plate 54 to the magnet contact 44, as described above, also pulls the flange 50 and connector assembly housing 64 toward the proximal end portion 46 of the power receiver arm 16, which forces the point contact 60 against the bias force of the spring 62 onto the annular electrode 48 to maintain good electrical contact.

As mentioned above, and as shown in FIGS. 11-14, the connector 36 is adjustable up and down in the connector assembly housing 64 to accommodate variations in distance from the input power receptacles R to the surfaces of various mobile electronic devices D (see FIGS. 9 and 10a-d)so that the bottom of the flange 50 of the connector assembly 20 and the bottom of the power receiver assembly 12 can be positioned flush or nearly flush with the top surface of the mobile electronic device D, as shown in FIG. 9, regardless of how far up or down the input power receptacle R is located in relation to the top surface of the mobile electronic device D. As best seen in FIG. 12, which has the connector assembly housing removed to reveal internal components, and in the FIGS. 13 and 14, the connector 36 is mounted in a block 66 (e.g., plastic) that is confined laterally in the housing 64 by shoulders 68, 70 in a manner that allows the block 66 to slide up and down. Electrically conductive contacts 72, 74 mounted in the block 66 are in slidable electric contact with electrically conductive rails 76, 78, respectively. One of the rails, e.g., rail 76, is connected to one of the contacts, e.g., point contact 60, and the other rail, e.g., rail 78, is connected to the other contact, e.g., plate contact 54 of the connector assembly 20. Also, the slidable contacts 72, 74 are connected electrically to opposite poles of the connector 36. Therefore, the connector 36 is connected electrically to the point contact 60 and the plate contact 54, regardless of where the connector is positioned upwardly or downwardly in the housing 64. The connections of the rails 76, 78 to the contacts 54, 60 can be reversed, if necessary, if the opposite polarity is needed at the connector 36. An optional ratchet or lock lever 80 can be provided on the block to interface with grooves or detents 82 to help retain the vertical position of the connector 36 in the housing 64. If the grooves or detents 82 are rounded, as shown in FIG. 13, they will resist, but not prevent movement of the block 66 and connector 36 either upwardly or downwardly. However, if the grooves 82 are shaped like notches and the lever 80 is shaped to match the notches, then movement in one direction, either up or down, many be allowed, but not both up and down. Therefore, the block 66 and connector 36 could be ratcheted in one direction, but prevented from moving in the other direction.

As seen in FIGS. 12 and 13, the power receiver hub 14 and power receiver arm 16 of the power receiver assembly 12 contain circuitry on a printed circuit board 84 that rectifies and conditions power received from the power delivery pad P (FIG. 1) for use by the mobile electronic device, including, but not necessarily limited to, providing proper voltage, and, optionally, other control functions, which is not part of this invention. Suffice it to say that in the conductive power transfer example illustrated in FIGS. 1, 12, and 13, power is received from the power delivery pad P through the power receiver contacts 18 in the power receiver hub 14, and those contacts 18 are connected electrically to the circuit components of the printed circuit board 84. As mentioned above, inductive power receiver elements would include one or more pickup coils (not shown) instead of the conductive contacts 18. After rectification and conditioning, the power is conducted or transmitted from the printed circuit board 84 to the magnet electrode 44 and annular electrode 48 by leads 86, 88, respectively. From the magnet electrode 44 and annular electrode 48, the conditioned power is connected to the connector 36 via the connector assembly 20 components as explained above. Magnets 90, 92, 94 in the power receiver hub 14 not only serve to hold the power receiver hub 14 tightly on the power delivery surface S of the power delivery pad P, which may comprise magnetic material for that purpose.

Since most commercially available mobile electronic devices D have plastic cases or housings, the power receiver assembly 12 can be attached to the device D by an adhesive. However, another option that allows secure attachment, yet easy removal and reattachment of the power receiver assembly to the mobile electronic device D incorporates use of the magnets 90, 92, 94 with an adhesive pad or anchor 100 that comprises magnetic material and an adhesive for adhering the adhesive pad or anchor 100 to the mobile electronic device D shown in FIG. 9.

With reference, now, primarily to FIGS. 9 and 13, the adhesive pad (sometimes called adhesive anchor) 100 comprises an adhesive layer 102 that can bond the pad 100 fairly permanently or semi-permanently to a surface of the mobile electronic device D. Then, since the power receiver assembly 12 has magnets 90, 92, 94 in the power receiver hub 14 for holding the power receiver hub 14 tightly on the power delivery surface S of the power delivery pad P, as explained above, those same magnets 90, 92, 94 can also hold the power receiver assembly 12 tightly on the adhesive pad 100, which also comprises magnetic material. Therefore, when the adhesive pad 100 is adhered or bonded to the surface of the mobile electronic device D, the magnets 90, 92, 94 hold the power receiver assembly 12 tightly onto the magnetic material of the adhesive pad 100, thus also tightly on the mobile electronic device D. Consequently, the magnetic attachment of the power receiver assembly 12 to the adhesive pad 100 and the magnetic attachment of the power receiver assembly 12 to the connector assembly 20 combine to form a unitary retrofit adapter with a pivot interface between the two and a secure but detachable attachment to the mobile electronic device D. Yet, like the magnetic attachment of the power receiver assembly 12 to the connector assembly 20 described above, the magnetic force can be overcome, so the power receiver assembly 12 can be detached from the mobile electronic device D by exerting enough force to overcome the magnetic forces. The pad 100 will stay adhered to the mobile electronic device D, but the power receiver assembly 12 and the connector assembly 20 can be separated and detached from the mobile electronic device D. Also, it can be reattached easily by simply placing the proximal end portion 46 over the connector assembly 20 and placing the distal end portion or power receiver hub 14 over the pad 100 and allow the magnetic forces to secure the power receiver assembly 12 to the connector assembly 20 and to the mobile electronic device D via the adhesive pad 100. A recess 96 in the bottom skin or shell 98 can be provided in a size and shape to receive some, if not all, of the adhesive pad 100 to allow the bottom surface of the power receiver assembly 12 to be at or close to the surface of the mobile electronic device D when it is attached.

The adhesive pad 100 can be wholly or partially a magnetic material. However, the example adhesive pad 100 shown in FIGS. 9 and 13 comprises a lower layer of resilient foam-type material, for example, a foamed silicone rubber, that can conform to a curvature in the surface of the mobile electronic device D, bonded to a rigid plate 106 of magnetic material. The top of the rigid plate can match the surface in the recess 96 for a tight, secure fit. Also, as shown in FIGS. 9 and 13, the bottoms of the magnets 90, 92, 94 are exposed in the recess 96 so that they can contact or very nearly contact the plate 106 of magnetic material, whereas there is a thickness of the non-magnetic skin or shell of the power receiver hub 14 on top of the magnets 90, 92, 94 which serve to hold the magnets at a distance of at least the thickness of the non-magnetic skin or shell from the power delivery surface S when the mobile electronic device D equipped with the universal power receiver adapter 10 is positioned on the power delivery pad P. Therefore, while the magnetic force attracting the power receiver hub 14 to the power delivery pad P is strong enough to hold the power receiver hub 14 tightly on and flush to the power delivery surface S, in spite of any imbalance of the mobile electronic device D over the power receiver hub 14, it will be weaker than the magnetic force attracting the power receiver hub 14 to the adhesive pad 100. Consequently, when the mobile electronic device D is pulled away from the power delivery pad P, the power receiver hub 14 will separate more readily from the power delivery surface S than from the adhesive pad 100, thereby leaving the power receiving assembly 12 firmly and securely attached to the mobile electronic device D.

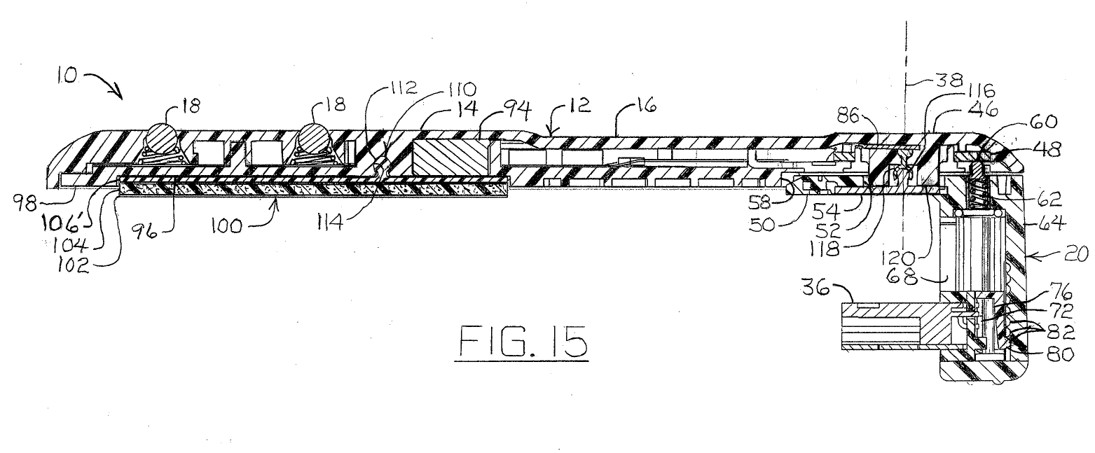

As mentioned above, the magnetic attachment of the power receiver arm 14 of the power receiver assembly 12 to the connector assembly 20 and a combination of adhesive and magnetic attachment of the power receiver assembly 12 to the mobile electronic device D as described above is one, but not necessarily the only, way to provide these easily attachable and detachable and rotatable functionalities. For example, but not for limitation, example mechanical attachments of the power receiver assembly 12 to the mobile electronic device D and/or of the power receiver arm 16 to the connector assembly 20 are illustrated in FIG. 15. In the FIG. 15 examples, the power receiver assembly 12 is releasably connected to the mobile device by a snap-type fastener assembly 110 comprising a bulbous protrusion or boss 112 extending upwardly from a plate 106′ of the adhesive pad 100, which was described above. A socket 114 in the power receiver hub 14 is sized and shaped to receive and retain the boss 112 in a resilient, releasable manner to releasably attach the power receiver assembly 12 to the adhesive pad 100, which, as explained above, can be adhered to the mobile electronic device D. With this snap-type assembly 110, the plate 106′ does not have to be a magnetic material, so it and the boss 112 are shown as a non-magnetic, plastic material, although it can be aluminum or any other appropriate material to suit the purpose. Of course, the snap-fastener assembly 110 can be structured and provided in any number of other ways that may or may not be part of an adhesive pad. Also, releasable attachments other than snap-type fasteners can also be used, or, if more permanent mountings of the power receiver assembly 12 to the mobile electronic device D are desired, unreleasable connectors or attachments can also be used.

The pivotal connection of the power receiver arm 16 to the connector assembly 20 can also be made in a non-magnetic manner, for example, but not for limitation, the pivotal mechanical connection shown in FIG. 15. In that example, a spindle 116 is shown extending upwardly from the metal plate 54 in the connector assembly 20 into releasable engagement with a socket or clip 118 in boss 120 of the power receiver arm 16 in a manner that allows rotation of the power receiver arm 16 about the axis 38 in relation to the connector assembly 20. The boss 120 extends into the hole 52 in the connector assembly 20. In this example, the spindle 116 and the socket or clip 118 are electrically conductive to make electrical connection of one leg of a circuit between the electrical components in the power receiver arm 20 and the plug, jack, or other connector 36 in the connector assembly 20. The socket or clip 118 can be connected electrically to the lead 86. The other leg of the circuit can comprise the annular plate 48 and point contact 60, as described above, or it can be done in myriad other ways. Therefore, when the power receiver arm 20 is pulled upwardly, away from the connector assembly 20, it can separate from the connector assembly 20, and, it can be re-assembled together with the connector assembly as shown in FIG. 15. Other rotatable electrical connection assemblies, either releasable or unreleasable, can also be used to connect the power receiver arm 16 to the connector assembly 20.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. Apparatus for retrofitting a mobile electronic device, which has an input power receptacle located on a side of the mobile electronic device, to receive power from a power delivery pad that has a flat power delivery surface on which one or more mobile electronic devices can be placed at random locations to receive power provided at the power delivery surface, comprising:
a connector assembly comprising a connector that is configured to mate with the input power receptacle;
power receiver means for receiving power from the power delivery surface; and
connector means for rotatably connecting the power receiver means to the connector assembly for transferring the power from the power receiver means to the connector assembly.

2. The apparatus of claim 1, wherein the power receiver means includes a power receiver arm extending between a proximal end and a distal end and includes a power receiver hub at the distal end with means for receiving the power from the power delivery surface, and wherein the connector means connects the proximal end of the power receiver means rotatably to the connector means so that the power receiver hub is movable in an arc at a distance from a pivot axis that extends through the connector means.

3. The apparatus of claim 2, wherein the distance is such that the arc in which the power receiver hub is movable over a part of the mobile electronic device that includes a longitudinal axis of the mobile electronic device.

4. The apparatus of claim 2, wherein the connector means includes magnetic electrode means for attaching the proximal end of the power receiver means rotatably and electrically to the connector means.

5. The apparatus of claim 2, including magnetic attachment means for connecting the power receiver means magnetically to the mobile electronic device.

6. The apparatus of claim 2, including magnetic attachment means for connecting the power receiver means magnetically to the mobile electronic device, and wherein the connector means includes magnetic electrode means for attaching the proximal end of the power receiver means rotatably and electrically to the connector means.

7. The apparatus of claim 6, wherein the magnetic attachment means includes a magnetic material that is bondable to the mobile electronic device and a magnet in the power receiver hub that applies a magnetic force that releasably attaches the power receiver means to the magnetic material.

8. The apparatus of claim 7, wherein the magnet in the power receiver hub is exposed in a manner that allows contact of the magnet with the magnetic material.

9. The apparatus of claim 8, wherein the magnet is also positioned in the power receiver hub in a manner that provides magnetic attraction force to the power receiver hub when the power receiver hub is positioned adjacent the power delivery surface of the power delivery pad to hold the power receiver hub tightly on the power delivery surface.

10. The apparatus of claim 9, wherein the power receiver hub includes a layer of non-magnetic material over the magnet to keep the magnet separated from the power delivery surface by at least the thickness of the layer of non-magnetic material so that the magnetic attraction force between the magnet and the power delivery pad is less than the magnetic attraction force between the magnet and the magnetic material that is adhered to the mobile electronic device.

11. The apparatus of claim 7, wherein the magnetic attachment means includes a foam-type pad that is bonded to a rigid plate of magnetic material, said foam-type pad being conformable and bondable to the mobile electronic device.

12. The apparatus of claim 1, wherein the connector is adjustable upwardly and downwardly in the connector assembly.

13. The apparatus of claim 12, including detent means in the connector assembly for resisting, but not preventing movement of the connector upwardly and downwardly in the connector assembly.

14. The apparatus of claim 12, including ratchet means in the connector assembly for allowing movement of the connector either upwardly or downwardly in the connector assembly, but not both upwardly and downwardly.

15. The apparatus of claim 1, including a plurality of interchangeable connector assemblies with differently configured connectors for adapting the power receiving means to a variety of mobile electrically powered devices that have differently configured input power receptacles.

16. The apparatus of claim 1, wherein the power receiver means for receiving power from the power delivery surface includes means for receiving the power inductively from the power delivery surface.

17. The apparatus of claim 1, wherein the means for receiving the power inductively from the power delivery surface includes an inductive pickup coil in the power receiver means for receiving power from an electromagnetic transmission coil in the power delivery pad.

18. The apparatus of claim 1, wherein the power receiver means for receiving power from the power delivery surface includes means for receiving the power conductively from the power delivery surface.

19. The apparatus of claim 18, wherein the means for receiving power conductively from the power delivery surface includes a plurality of power receiver contacts for establishing electrical contact with oppositely charged portions of the power delivery surface.

20. Apparatus for retrofitting a mobile electronic device, which has an input power receptacle located on a side of the mobile electronic device, to receive power from a power delivery pad that has a flat power delivery surface on which one or more mobile electronic devices can be placed at random locations to receive power provided at the power delivery surface, comprising:
a connector assembly comprising a connector that is configured to mate with the input power receptacle; and
a power receiver assembly rotatably and electrically connectable to the connector assembly in a manner that enables power received by the power receiver assembly from the power delivery pad to flow from the power receiver assembly into the connector assembly in a range of angular positions of the power receiver assembly in relation to a pivot axis that extends through the connector assembly.
connector means for rotatably connecting the power receiver means to the connector assembly for transferring the power from the power receiver means to the connector assembly.

21. The apparatus of claim 20, wherein the power receiver assembly includes a power receiver arm extending between a proximal end and a distal end and includes a power receiver hub at the distal end, and wherein the power receiver hub is at a fixed distance from the pivot axis that allows the power receiver hub to pivot at distance from a pivot axis in an arc that extends over a part of the mobile electronic device that includes a longitudinal axis of the mobile electronic device.

22. The apparatus of claim 21, including an adhesive anchor that is bondable to the mobile electronic device at a location where the arc is over the longitudinal axis, wherein said adhesive anchor includes a magnetic material, and wherein the power receiver hub has a magnet that, when positioned over the adhesive anchor, applies a magnetic force to the power receiver hub that releasably attaches the power receiver hub to the mobile electronic device at a location where the arc is over the longitudinal axis of the mobile electronic device.

23. The apparatus of claim 22, wherein the adhesive anchor comprises a foam pad that is conformable to the surface of the mobile electronic device bonded to a rigid plate of magnetic material and an adhesive layer on the foam pad for adhering the foam pad to the mobile electronic device.

24. The apparatus of claim 22, wherein the proximal end of the power receiver assembly is pivotally and electrically connectable to the connector assembly by a magnet electrode that protrudes from the proximal end of the power receiver assembly into a hole in the top of the housing of the connector assembly to contact an electrically conductive contact plate of magnetic material in the connector assembly to provide a detachable magnetic attachment and electrical connection of the power receiver assembly to the connector assembly.

25. The apparatus of claim 23, including an annular electrode around the magnet electrode on the bottom of the proximal end of the power receiver assembly, and a point contact protruding from the top of the connector assembly into contact with the annular electrode so that there is electrical connection between the power receiver assembly and the connector assembly through a range of angular orientations of the power receiver assembly with respect to the connector assembly.

26. The apparatus of claim 20, including an interchangeable alternate connector assembly with a differently configured connector.

27. The apparatus of claim 20, wherein the connector is mounted in a block that is adjustable upwardly and/or downwardly in a connector assembly housing.

28. The apparatus of claim 27, wherein the connector assembly includes a pair of vertical rails that extend from the bottom of the connector assembly housing into electrical connection with the contact plate and the point contact, respectively, and wherein the block includes a pair of slidable contacts that are connected to respective opposite electrical poles of the connector and that are in sliding contact with respective ones of the rails so that electrical connection of the connector to the rails and to the plate electrode and the point electrode is not broken during movement of the connector up and/or down in the connector assembly housing.

29. The apparatus of claim 27, including detent grooves and mating biased latch that resist, but do not prevent, movement of the block and connector up and down in the connector assembly housing.

30. The apparatus of claim 27, including notched ratchet grooves and mating ratchet latch that are shaped to allow adjustment of the block and connector in only one direction in the connector assembly housing.

31. A method of retrofitting a mobile electronic device, which has an input power receptacle located on a side of the mobile electronic device, to receive power from a power delivery pad that has a flat power delivery surface on which one or more mobile electronic devices can be placed at random locations to receive power provided at the power delivery surface, comprising:
connecting a connector that is part of a connector assembly to the input power receptacle;
connecting a proximal end portion of a power receiver assembly pivotally and electrically to the connector assembly;
pivoting the power receiver assembly about a pivot axis that extends through the connector assembly so that a power receiver hub at the distal end portion of the power receiver assembly at a fixed distance from the pivot axis moves in an arc over a portion of the top surface of the mobile electronic device until the power receiver hub centers over a longitudinal axis of the mobile electronic device;
attaching the power receiver hub by adhesive to the top surface of the mobile electronic device.

32. The method of claim 31, wherein the attaching of the power receiver hub by adhesive to the top surface of the mobile electronic device includes:
adhering an anchor comprising magnetic material to the top surface of the mobile electronic device; and
releasably attaching the power receiver hub to the anchor with a magnet positioned in the power receiver hub.

33. The method of claim 32, including rotatably, releasably, and electrically connecting the proximal end portion of the power receiver assembly to the connector assembly by a magnet electrode in the proximal end portion of the power receiver assembly applying magnetic attraction force to a plate contact comprising magnetic material in the connector assembly.

34. The method of claim 32, including adjusting the connector upwardly or downwardly in the connector assembly so that the bottom of the power receiver assembly is flush with the top surface of the mobile electronic device when the power receiver assembly is attached to the connector assembly.

35. The method of claim 32, wherein the anchor comprises a foam pad that is bonded to a rigid plate of magnetic material and that is conformable to the top surface of the mobile electronic device, and including adhering the foam pad to the top surface of the mobile electronic device.

36. The method of claim 31, including forming the power receiver assembly with the distance from the pivot axis to the center of the power receiver hub selected to be a distance that accommodates placement of the center of the poser receiver hub over the longitudinal axis of a variety of mobile electronic devices when the connector assembly is connected to the input power receptacles of such variety of mobile electronic devices.

37. The apparatus of claim 2, wherein rotatable attachment means includes a magnetic electrode that makes a releasable, electrical connection between the power receiver means and the connector means.

38. The apparatus of claim 37, wherein the rotatable attachment means includes an electrically conductive spindle and socket assembly that makes releasable, electrical connection between the power receiver means and the connector means.

39. The apparatus of claim 20, wherein rotatable attachment means includes a magnetic electrode that makes a releasable, electrical connection between the power receiver means and the connector means.

40. The apparatus of claim 39, wherein the rotatable attachment means includes an electrically conductive spindle and socket assembly that makes releasable, electrical connection between the power receiver means and the connector means.

41. The apparatus of claim 21, including an adhesive anchor that is bondable to the mobile electronic device at a location where the arc is over the longitudinal axis, wherein said adhesive anchor includes a snap fastener boss, and wherein the power receiver hub has a snap fastener socket that, interacts with the snap fastener boss in a manner that releasably attaches the power receiver hub to the mobile electronic device at a location where the arc is over the longitudinal axis of the mobile electronic device.

42. The apparatus of claim 41, wherein the adhesive anchor comprises a foam pad that is conformable to the surface of the mobile electronic device bonded to a rigid plate of magnetic material and an adhesive layer on the foam pad for adhering the foam pad to the mobile electronic device.

43. The method of claim 31, wherein the attaching of the power receiver hub by adhesive to the top surface of the mobile electronic device includes:
adhering an anchor comprising a first part of a snap fastener to the top surface of the mobile electronic device; and
releasably attaching the power receiver hub to the anchor with a second part of the snap fastener positioned in the power receiver hub.
